(19) United States
(12) Patent Application Publication
(10) Pub. No.: US 2015/0160034 A1
(43) Pub. Date: Jun. 11, 2015

(54) ROUTE GUIDANCE APPARATUS AND METHOD USING DRIVE LANE RECOGNITION

(71) Applicant: Hyundai Motor Company, Seoul (KR)

(72) Inventors: Jae Kwang KIM, Seoul (KR); Kyung Ho YOO, Seoul (KR); Sung Won YOON, Yongin-Si (KR)

(21) Appl. No.: 14/326,308

(22) Filed: Jul. 8, 2014

(30) Foreign Application Priority Data
Dec. 9, 2013 (KR) 10-2013-0152441

(51) Int. Cl. G01C 21/36

(52) U.S. Cl. CPC G01C 21/3626

(57) ABSTRACT

A route guidance apparatus includes a location information generator, a route configurer, a road lane configurer, a controller, and an output unit. The location information generator is configured to generate location information. The route configurer is configured to configure a drive route to a destination using the location information, map information, and traffic information. The road lane configurer is configured to photograph a drive lane on the drive route. The controller is configured to process data obtained from the road lane configurer and the route configurer. The output unit is configured to output guidance information of the drive lane.

### CROSS-REFERENCE TO RELATED APPLICATION

This application is based on and claims priority from Korean Patent Application No. 10-2013-0152441, filed on Dec. 9, 2013 in the Korean Intellectual Property Office, the entire content of which is hereby incorporated by reference.

### TECHNICAL FIELD

The present inventive concept relates to an apparatus and method of route guidance using drive lane recognition, and more particularly, to an apparatus and method for guiding a point of time when a drive lane is changed according to a drive route.

### BACKGROUND

A navigation terminal device provides numerous pieces of information such as information of a current location of a vehicle, information of a route to a destination, map matching performing information based on the location information and the route information, etc. to a user.

A conventional navigation terminal device simply searches for a route to a destination and guides the searched route. In addition, the conventional navigation terminal device does not provide information about a road situation after a vehicle passes through a specific point on the searched route to a user, and thus, the user goes through inconvenience in that a road situation is not fast handled.

In addition, even if the conventional navigation terminal device provides information about a lane of a road, only uniform information at a preset guidance point is provided irrespective of a state of a lane of a road or a traffic condition, and thus, the user is provided with such unnecessary information.

### SUMMARY

Accordingly, the present inventive concept has been made to solve the above-mentioned problems occurring in the prior art while advantages achieved by the prior art are maintained intact.

One object to be achieved by the present inventive concept is to provide a route guidance apparatus and method, for recognizing a drive lane of a vehicle, recognizing whether a drive lane is changed, and guiding a point of time when the drive lane is changed, using navigation information.

One aspect of the present inventive concept relates to a route guidance apparatus including a location information generator configured to generate location information, a route configurer configured to configure a drive route to a destination using the location information, map information, and traffic information, a road lane configurer configured to photograph a drive lane on the drive route, a controller configured to process data obtained from the road lane configurer and the route configurer, and an output unit configured to output drive lane guidance information.

The controller may be configured to control a data storage, an image data processor, a determiner of output data, and a route guider.

The controller may be configured to perform a Hough transform method on data about the drive lane, transmitted from the road lane configurer, to detect a lane number of the drive lane.

The route guidance apparatus may be configured to determine the drive lane and a point of time when the drive lane is changed among data about the drive lane, transmitted from the road lane configurer, using an algorithm.

Another aspect of the present inventive concept encompasses a route guidance method including determining whether a drive route of a driving vehicle is changed. After determining whether the drive route is changed, a location of the vehicle is recognized by a location information generator. After recognizing the location of the vehicle, road information containing the number of lanes of a road is recognized by a route configurer. After recognizing the road information, a lane number of a drive lane is recognized by a road lane configurer, and then front lane information is recognized by the road lane configurer. It is determined whether the drive lane is changed and a point of time when the drive lane is changed, by a controller is determined, based on the lane information recognized by the road lane configurer, and information on the number of lanes recognized by the route configurer. Change in the drive lane is indicated by an output unit.

A data storage, an image data processor, a determiner of output data, and a route guider may be controlled by the controller.

A Hough transform method may be performed by the controller on data about a drive lane, transmitted from the road lane configurer, to detect a lane of the drive lane.

The drive lane and a point of time when the drive lane is changed among data about the drive lane, transmitted from the road lane configurer may be determined using an algorithm.

### BRIEF DESCRIPTION OF THE DRAWINGS

The above and other objects, features and advantages of the present inventive concept will be more apparent from the following detailed description taken in conjunction with the accompanying drawings, in which like reference characters may refer to the same or similar parts throughout the different views. The drawings are not necessarily to scale, emphasis instead being placed upon illustrating the principles of the embodiments of the inventive concept.

FIG. 1 is a block diagram illustrating main components of a route guidance apparatus according to an exemplary embodiment of the present inventive concept.

FIG. 2 is a flowchart of a route guidance method according to an exemplary embodiment of the present inventive concept.

FIG. 3 is a diagram for explanation of a method of determining a drive lane according to an exemplary embodiment of the present inventive concept.

FIG. 4 is a diagram for explanation of a point of time when a drive lane is changed according to an exemplary embodiment of the present inventive concept.

### DETAILED DESCRIPTION

Hereinafter, exemplary embodiments of the present inventive concept will be described in detail with reference to the accompanying drawings.

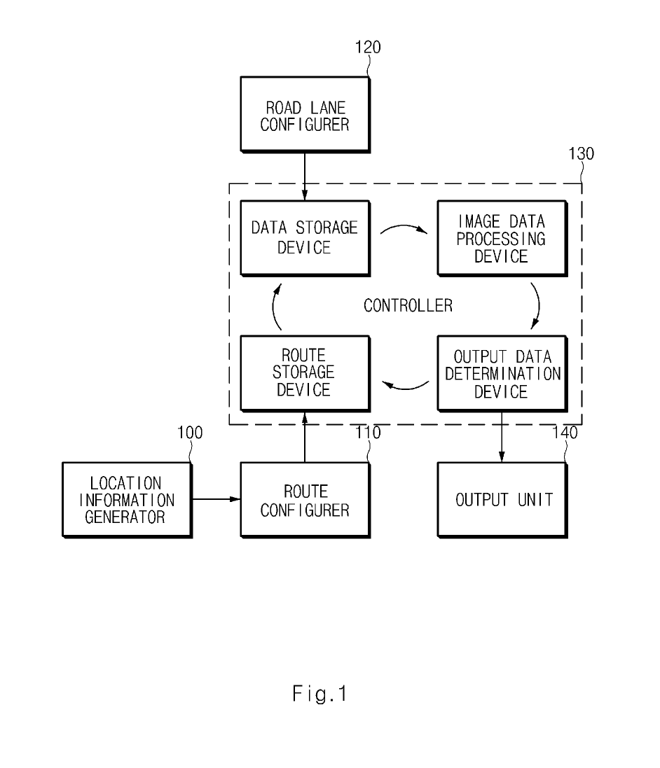

FIG. 1 is a block diagram illustrating main components of a route guidance apparatus according to an exemplary embodiment of the present inventive concept.

Referring to FIG. 1, the route guidance apparatus according to the present embodiment may include a location information generator 100, a route configurer 110, a road lane configurer 120, a controller 130, and an output unit 140, all of which may be implemented using a microprocessor and/or a dedicated hardware and/or memory (either magnetic tape, a magnetic drum, magnetic disks, CDs, optical storage, RAM, ROM, EEPROM, EPROM, flash memory, and/or like storage media).

The location information generator 100 may receive radio waves from a satellite to generate location information. In addition, the location information generator 100 may receive radio waves such as mobile communication waves, etc. from a radio wave transmitting apparatus to generate location information. For example, the location information generator 100 may generate the location information using satellite waves, mobile communication waves, and information provided from a vehicle (mobile information using an angle of the steering wheel, a current speed, etc., road lane information via a camera installed in a vehicle, etc.). In addition, the location information generator 100 may provide the generated location information to the route configurer 110.

The route configurer 110 may configure a drive route to a destination. Here, the route configurer 110 may configure the drive route to the destination using the location information of the vehicle. In addition, the route configurer 110 may recognize current road information through the location information generator 100. For example, the route configurer 110 may recognize the current road information through a navigation device.

The road lane configurer 120 may configure a drive lane on the drive route. The road lane configurer 120 may check if there exist lane joining, lane divergence, expansion of the number of lanes, or reduction of the number of lanes at a front node, i.e., a point ahead of the current location where lane changing occurs, through a camera. Here, the camera may be a front camera and may be installed in or outside the vehicle.

In addition, the road lane configurer 120 may check an average vehicle velocity on the configured drive route using the location information and the traffic information. In addition, the road lane configurer 120 may generate lane changing guidance information containing information about a drive lane, a lane changing point, or a distance to the lane changing point.

In detail, the road lane configurer 120 may check a location of the vehicle through the location information and check a lane state of the front node on the drive route through map information. Here, the lane state may be classified into lane joining, lane divergence, lane expansion, and lane reduction. In addition, a node may refer to a point where lane changing occurs.

In addition, the road lane configurer 120 may reflect traffic information on the drive route to configure a drive recommendation lane.

According to an exemplary embodiment of the present inventive concept, the road lane configurer 120 may check traffic information per lane on the drive route to configure the drive recommendation lane. Here, the traffic information per lane may include information such as traffic volume or average vehicle speed per road lane with respect to a node or a link. In this case, the link may indicate a road section connecting nodes.

The controller 130 may receive both image data containing the location information of the vehicle and the road information, transmitted from the route configurer 110, and data about the drive lane, transmitted from the road lane configurer 120. The controller 130 may store data, process image data, determine data, and control all data about route guidance.

In addition, the controller 130 may perform a Hough transform method on the data about the drive lane, transmitted from the road lane configurer 120 to detect a road lane. The Hough transform method is mainly used in a computer vision field and is mainly used to detect straight lines from an image.

The output unit 140 may output a route to a destination. In addition, the output unit 140 may output the lane changing guidance information. Here, the output unit 140 may output the lane changing guidance information provided from the road lane configurer 120 in a video or audio form. The output unit 140 may output a drive lane of the lane changing guidance information, a lane changing point of time, or a distance to the lane changing point of time in a video or audio form. For example, the output unit 140 may output guidance about lane change about 1 km ahead in a video or audio form.

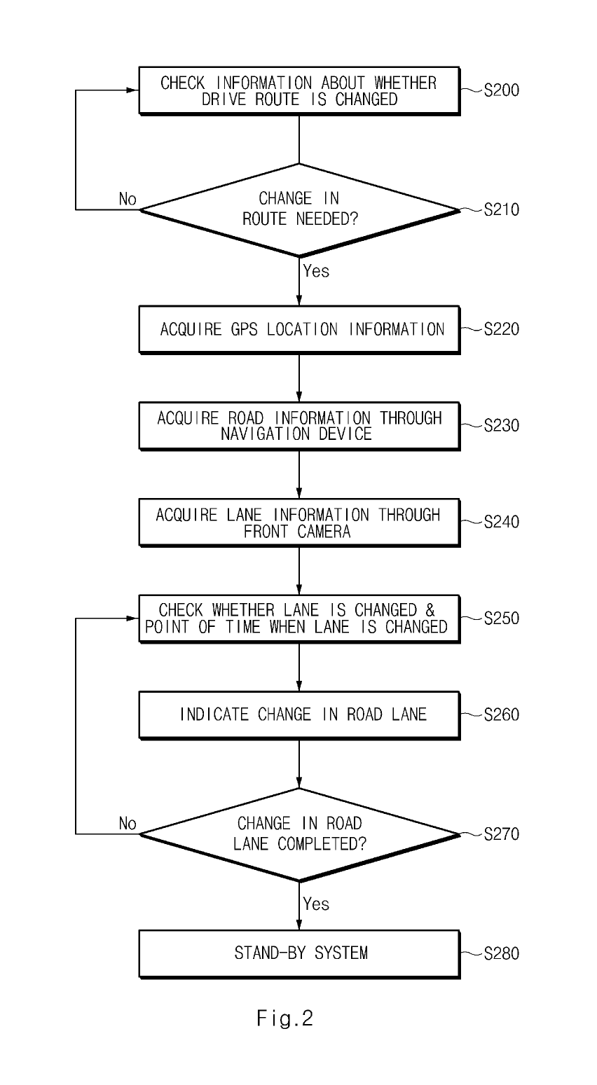

FIG. 2 is a flowchart of a route guidance method according to an exemplary embodiment of the present inventive concept.

Referring to FIG. 2, it may be checked or determined whether a drive route of a driving vehicle is changed (S200). For example, it may be checked via a navigation device whether entrance into an expressway or change into another lane or the like occurs on a drive route.

Then, it may be checked whether change of the drive route occurs is checked (S210) and then, a current location of a vehicle may be recognized by a location information generator (S220).

Then, a route configurer may recognize road information such as the number of lanes of a road (S230). For example, the route configurer may recognize the current information of the road through a navigation device.

Then, a road lane configurer recognizes the drive lane and recognizes information of a front lane, i.e., a lane ahead of the current location (S240). Here, the road lane configurer may recognize the information of the front lane using a front camera.

Then, data information about lane information of the road lane configurer, and the number of lanes of the route configurer may be controlled to recognize whether the road lane is changed or a point of time when the road lane is changed (S250).

Then, an output unit may indicate change in road lane (S260).

Then, it may be checked or determined whether the change in the road lane is completed (S270). When it is determined that the change in the road lane is completed, a current state may be changed to or remain a system stand-by state (S280), and when it is determined that the change in the road lane is not completed, it may be re-checked whether the road lane is changed and a point of time when the road lane is changed.

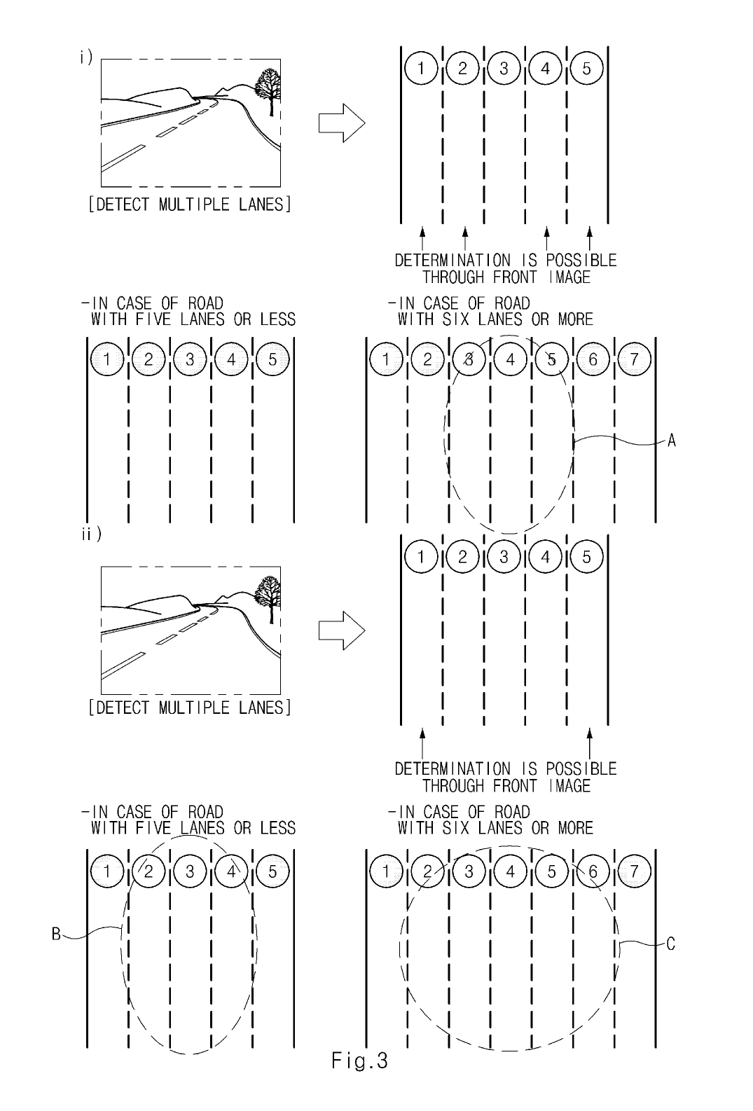

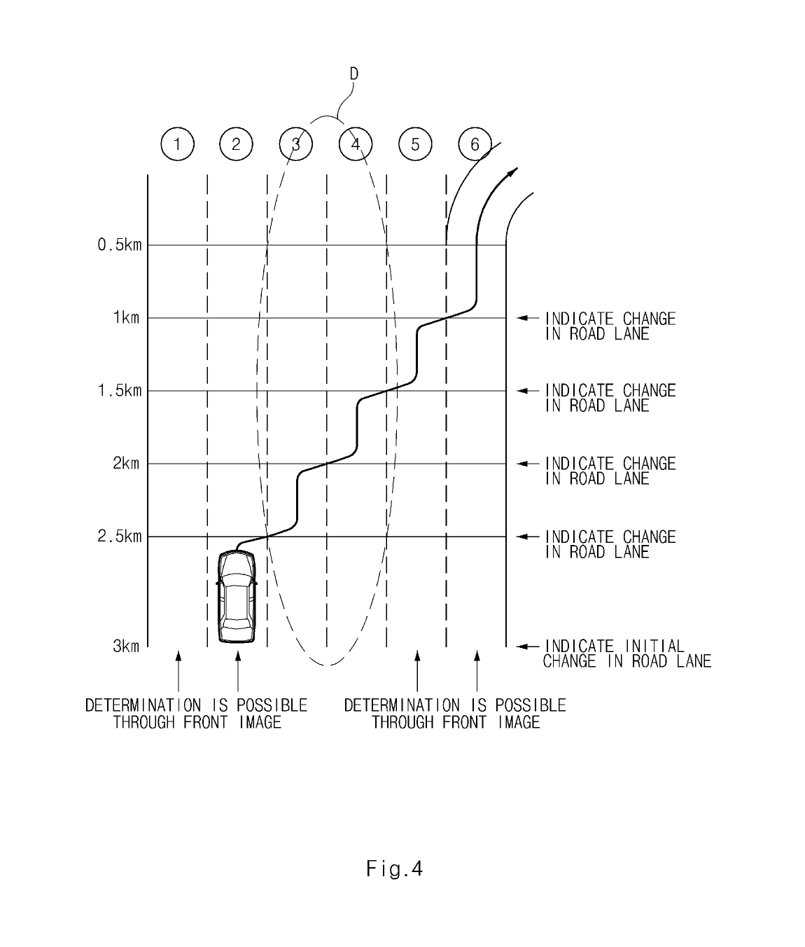

A method of determining the drive lane and a method of processing an algorithm about the point of time when the road lane is changed among the data about the drive lane, transmitted from the road lane configurer 120, will be described with reference to FIGS. 3 and 4.

FIG. 3 is a diagram for explanation of a method of determining a drive lane according to an exemplary embodiment of the present inventive concept.

i) The method of determining the drive lane may vary according to a recognition rate of a front camera, but will be described on the assumption that a drive lane and both side lanes thereof are considered as two lanes. In this case, the recognized lane may include road lanes indicated by solid lines or dotted lines (see FIG. 3).

First, all road lanes may be accurately recognized on an expressway having 5 lanes or less.

For example, with regard to a vehicle that drives on a 5-lane expressway, both external lines of first and fifth lanes may be indicated by solid lines to recognize a road lane, and second and fourth lanes, next to the first and fifth lanes, respectively, may also be recognized by the front camera.

However, when the vehicle drives on a third lane, the third lane recognizable by the front camera may be indicated by dotted lines, and thus, it may be difficult to determine a degree or distance by which the third lane is spaced apart from the external line (indicated by solid lines).

However, when information indicating that a road on which the vehicle drives is a 5-lane road is already known or obtained through global positioning system (GPS) information or navigation information, it may be estimated that the vehicle drives on the third lane. Thus, all lanes on an expressway with 5 lanes or less may be accurately recognized.

On the other hand, all road lanes may not be accurately recognized on an expressway with 6 lanes or more.

For example, with regard to a vehicle that drives on a 7-lane expressway, first and second lanes or sixth and seventh lanes from both external lines may be recognized. However, the remaining third, fourth, and fifth lanes may not be accurately recognized due to a recognition rate of the front camera. The remaining lanes that are not differentiated from each other due to the low recognition rate may be referred to as an intermediate lane A (see FIG. 3). The intermediate lanes A may be recognized as one lane. That is, the intermediate lane A may include a plurality of lanes, and thus, a distance for indicating a point of time when a drive lane is subsequently changed may be configured as a maximum value to recognize the point of time when the drive lane is changed.

ii) The method of determining the drive lane, on which lane the vehicle is driving, may vary according to a recognition rate of a front camera, but will be described on the assumption that only a lane (one lane) of the drive lane, on which the vehicle drives, is recognized (indicated by solid or dotted lines of a front lane).

All road lanes may not be accurately recognized on an expressway with 2 lanes or more.

First, for example, with regard to a vehicle that drives on a 5-lane expressway, only both external lines of first and fifth lanes may be recognized, and the remaining second, third, and fourth lanes may not be accurately recognized due to a recognition rate of the front camera. The remaining lanes that are not differentiated from each other due to the low recognition rate may be referred to as an intermediate lane B (see FIG. 3), and the intermediate lanes B may be recognized as one lane. That is, the intermediate lane B may include a plurality of lanes, and thus, a distance for indicating a point of time when a drive lane is subsequently changed may be configured as a maximum value to accurately recognize the point of time when the drive lane is changed.

Next, with regard to a vehicle that drives on a 7-lane expressway, only both external lines of first and seventh lanes may be recognized, and the remaining second, third, fourth, fifth, and sixth lanes may not be accurately recognized due to a recognition rate of the front camera. The remaining lanes that are not differentiated from each other due to the low recognition rate may be referred to as an intermediate lane C (see FIG. 3). That is, the intermediate lane C may include a plurality of lanes, and thus, a distance for indicating a point of time when a drive lane is subsequently changed may be configured as a maximum value to recognize the point of time when the drive lane is changed.

The algorithm for determining a point of time when a drive lane is changed may be processed based on a drive lane recognized using the aforementioned drive lane determination method.

i) When the drive lane is accurately recognized, a point of time when the drive lane is changed is now described. Initial route guidance time (x) may be calculated according to 1000 m+((t-d)×500 m), with a drive lane (number) (d), a change target lane (number) (t), and number of changeable lanes (t-d). Route guidance after initial route guidance may be configured in units of 500 m at the initial route guidance time. A distance at initial route guidance time may be optimized through simulation.

ii) When the drive lane is not accurately recognized, a point of time when the drive lane is changed is now described. Initial route guidance time (x) may be calculated according to 1000 m+((n−1)×500 m), with lane number (n) of a current road. Route guidance after initial route guidance may be configured in units of 500 m at the initial route guidance time. Here, when the drive lane is not accurately recognized, the initial route change time may be configured as a maximum value. A distance at initial route guidance time may be optimized through simulation.

FIG. 4 is a diagram for explanation of a point of time when a drive lane is changed according to an exemplary embodiment of the present inventive concept.

Referring to FIG. 4, a case in which a vehicle drives on a second lane on a 6-lane expressway is exemplified. In addition, the point of time will be described on the assumption that the vehicle recognizes the drive lane and lanes next to the drive lane. In this case, the recognized lanes may include lanes indicated by solid or dotted lines (see FIG. 4). That is, it may be possible to accurately recognize first, second, fifth, and sixth lanes among six lanes, and it is difficult to accurately recognize third and fourth lanes, and thus, the third and fourth lanes may be classified as intermediate lanes D (see FIG. 4).

When a user wants to change a current lane of the vehicle to a sixth lane in order to arrive a predicted point, route changing guidance may be performed using an algorithm for determining the point of time when the road lane is changed, which is illustrated in FIG. 3.

When the drive lane of the vehicle is accurately recognized, initial route changing guidance time (x) may be calculated according to 1000 m+((t-d)×500 m), with a drive lane (number) (d), a change target lane (number) (t), and number of changeable lanes (t-d). That is, initial route changing guidance may be performed at 3 km from changing a current lane of the vehicle to a sixth lane, and after the initial route changing guidance, route changing guidance may be continuously performed in units of 500 m until final route change is completed. A distance at the initial route guidance time may be optimized through simulation and may vary.

However, when the drive lane of the vehicle is not accurately recognized, initial route changing guidance time (x) may be calculated according to 1000 m+((n−1)×500 m), with lane number (n) of a current road. That is, initial route changing guidance is performed at 3.5 km from changing a current lane of the vehicle to a sixth lane, and after the initial route changing guidance, route changing guide may be continuously performed in units of 500 m until final route change is completed. A distance at the initial route guidance time may be optimized through simulation and may vary.

As described above, according to the present inventive concept, a point of time when a drive lane may be accurately recognized, thereby enhancing driver convenience and preventing negligent accident due to sudden change in lane. In addition, according to the present inventive concept, the number of lanes of a road and a location of a vehicle may be recognized via a navigation device, and front lane information may be recognized using a front camera, and thus, the driver may accurately recognize a drive route.

According to exemplary embodiments of the present inventive concept, a point of time when a drive lane is changed may be accurately recognized, thereby enhancing driver convenience and preventing negligent accidents due to sudden change in lane.

In addition, according to exemplary embodiments of the present inventive concept, the number of lanes of a road and a location of a vehicle may be recognized via a navigation device, and front lane information may be recognized using a front camera, and thus, the driver may accurately recognize a drive route.

It should be interpreted that the scope of the present inventive concept is defined by the following claims rather than the above-mentioned detailed description and all modifications or alterations deduced from the meaning, the scope, and equivalences of the claims are included in the scope of the present inventive concept.

What is claimed is:

1. A route guidance apparatus, comprising:
a location information generator configured to generate location information;
a route configurer configured to configure a drive route to a destination using the location information, map information, and traffic information;
a road lane configurer configured to photograph a drive lane on the drive route;
a controller configured to process data obtained from the road lane configurer and the route configurer; and
an output unit configured to output guidance information of the drive lane.

2. The route guidance apparatus according to claim 1, wherein the controller is configured to control a data storage, an image data processor, a determiner of output data, and a route guider.

3. The route guidance apparatus according to claim 1, wherein the controller is configured to perform a Hough transform method on data on the drive lane, transmitted from the road lane configurer, to detect a lane number of the drive lane.

4. The route guidance apparatus according to claim 1, wherein the route guidance apparatus is configured to determine the drive lane and a point of time when the drive lane is changed among data about the drive lane, transmitted from the road lane configurer, using an algorithm.

5. A route guidance method, implemented by a route guidance apparatus having instructions, the execution of the instructions causing the route guidance apparatus to perform the following steps including:
determining whether a drive route of a driving vehicle is changed;
after determining whether the drive route is changed, recognizing a location of the vehicle by a location information generator;
after recognizing the location of the vehicle, recognizing road information containing the number of lanes of a road by a route configurer;
after recognizing the road information, recognizing a lane number of a drive lane by a lane configurer, and then recognizing front lane information by the lane configurer;
determining whether the drive lane is changed and recognizing a point of time when the drive lane is changed, by a controller, based on the lane information recognized by the lane configurer and information on the number of lanes recognized by the route configurer; and
indicating, by an output unit, change in the drive lane.

6. The route guidance method according to claim 5, further comprising: controlling, by the controller, a data storage, an image data processor, a determiner of output data, and a route guider.

7. The route guidance method according to claim 5, further comprising: performing, by the controller, a Hough transform method on data about a drive lane, transmitted from the road lane configurer, to detect a lane of the drive lane.

8. The route guidance method according to claim 5, further comprising: determining the drive lane and a point of time when the drive lane is changed among data about the drive lane, transmitted from the road lane configurer, using an algorithm.
